(19) United States
(12) Patent Application Publication
(10) Pub. No.: US 2007/0095086 A1
(43) Pub. Date: May 3, 2007

(54) Cooling apparatus and cooling method for electric storage device of electrically powered vehicle

(75) Inventors: Junya Tsuneishi, Utsunomiya-shi (JP); Yoshiaki Takahashi, Kawachi-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/585,081

(22) Filed: Oct. 24, 2006

(30) Foreign Application Priority Data
Oct. 28, 2005 (JP) 2005-314198

(51) Int. Cl. B60H 3/00; F25D 23/12; B60H 1/32

(52) U.S. Cl. 62/244; 62/259.2; 165/42

(57) ABSTRACT

This cooling apparatus for a condenser of an electrically powered vehicle including a vehicle driving motor to which an electrical power is supplied from a condenser through an inverter, includes: a cooler including a fan which sends a cooling air into a cabin interior; a suction port which is open to the cabin interior so as to suck the cooling air and supplies the cooling air toward the condenser; and a controller which increases the number of rotations of the fan when the fan is in operation and a temperature of the condenser exceeds a first predetermined value.

### BACKGROUND OF THE INVENTION

Priority is claimed on Japanese Patent Application No. 2005-314198, filed Oct. 28, 2005, the contents of which are incorporated herein by reference.

1. Field of the Invention

The present invention relates to a cooling apparatus and a cooling method for an electric storage device of electrically powered vehicles such as a hybrid vehicle and an electric vehicle, equipped with a vehicle driving motor to which electrical power is supplied from the electric storage devices such as a battery and a capacitor through an inverter. In especially, the present invention relates to a cooling apparatus and a cooling method for an electric storage device of an electrically powered vehicle, which cools the electric storage device by utilizing cooling air supplied into a cabin interior from a cooler.

2. Description of the Related Art

Electrically powered vehicles such as a hybrid vehicle and an electric vehicle are provided with a high-voltage condenser which supplies electrical power to a motor generator during driving, and which is charged with electrical power generated by the motor generator during decelerating. This condenser is normally housed in an electrical equipment box together with high-voltage electrical equipments such as a PDU (Power Drive Unit) and a DC-DC converter, and is positioned at a position behind rear seats where is isolated from a cabin interior.

Since the electrically powered vehicles use the high-voltage condensers, the amount of heat generated by driving the motor or by charging it is large. In order to treat such heat generation, a cooling apparatus for a condenser of an electrically powered vehicle has been developed which introduces cooling air supplied into a cabin interior from a cooler to an accommodating space of the condenser through a suction port which is open to the cabin interior, and thereby cooling the condenser (for example, refer to Japanese Patent No. 3,125,198).

In this cooling apparatus for a condenser of an electrically powered vehicle, the cooler is operated in accordance with the temperature of the condenser for driving and regeneration. However, for example, when ambient temperature outside the vehicle is high or when insolation intensity inside the cabin interior is increased by sunshine reaching to the cabin interior through window glasses, there is a case in which the cooling air blown from a blower is warmed before reaching to the suction port, and thereby preventing quick cooling of the condenser.

Accordingly, the present invention has an object of providing a cooling apparatus for a condenser of an electrically powered vehicle which can promptly cool a condenser when temperature of the condenser for driving and regeneration increases.

### SUMMARY OF THE INVENTION

In order to achieve the above-mentioned object, the present invention employs the followings.

That is, the present invention employs a cooling apparatus for an electric storage device of an electrically powered vehicle including a vehicle driving motor to which an electrical power is supplied from an electric storage device through an inverter, including: a cooler including a fan which sends a cooling air into a cabin interior; a suction port which is open to the cabin interior so as to suck the cooling air and supplies the cooling air toward the electric storage device; and a controller which increases the number of rotations of the fan when the fan is in operation and a temperature of the electric storage device exceeds a first predetermined value.

According to the cooling apparatus for an electric storage device of an electrically powered vehicle, when the cooler is in operation and if the temperature of the electric storage device exceeds the first predetermined value, the controller increases the number of rotations of the fan of the cooler. As the result, the flow rate of the cooling air to be supplied into the suction port increases. Accordingly, the electric storage device can be cooled promptly since an adequate flow rate of the cooling air to be supplied into the suction port can be secured.

It may be arranged such that when the fan is in operation and the temperature of the electric storage device exceeds the first predetermined value, the controller switches an air-supplying mode of the cooler to a cabin-interior-air circulation mode.

In this case, when the cooler is in operation, if the temperature of the electric storage device increases and exceeds the first predetermined value, the controller increases the number of rotations of the fan of the cooler and also switches the air-supplying mode of the cooler to the cabin-interior-air circulation mode. As the result, the cooling air will be supplied to the suction port while terminating introducing of an ambient air. Accordingly, since introducing of the ambient air which has comparatively higher temperature can be terminated, the electric storage device can be effectively cooled.

It may be arranged such that the cooling apparatus for an electric storage device of an electrically powered vehicle further includes an ambient temperature measuring device which measures an ambient temperature outside the electrically powered vehicle, wherein a requirement for the controller to increase the number of rotations of the fan further includes that a temperature at a cabin exterior exceeds a second predetermined value.

In this case, when the temperature of the electric storage device while operating it increases and exceeds the first predetermined value and the temperature measured by the ambient temperature measuring device exceeds the second predetermined value, the controller increases the number of rotations of the fan, and thereby increasing the flow rate of the cooling air supplied from the fan to the suction port. Accordingly, even when cooling performance for the electric storage device is lowered due to increasing ambient temperature, the electric storage device can be cooled promptly by the adequate flow rate of cooling air to be supplied to the suction port.

It may be arranged such that the cooling apparatus for an electric storage device of an electrically powered vehicle further includes an insolation intensity measuring device which measures an insolation intensity, wherein a requirement for the controller to increase the number of rotations of the fan further includes that the insolation intensity exceeds a third predetermined value.

In this case, when the temperature of the electric storage device while operating it increases and exceeds the first predetermined value and the insolation intensity measured by the insolation intensity measuring device exceeds the third predetermined value, the controller increases the number of rotations of the fan, and thereby increasing the flow rate of the cooling air supplied from the fan to the suction port. Accordingly, even when cooling performance for the electric storage device is lowered due to increasing insolation intensity, the electric storage device can be cooled promptly by the adequate flow rate of cooling air to be supplied to the suction port.

In addition, the present invention also employs a cooling method for an electric storage device of an electrically powered vehicle including a vehicle driving motor to which an electrical power is supplied from an electric storage device through an inverter, the electric storage device being cooled by a cooling air supplied from a cooler by a fan of the cooler, the cooling method for an electric storage device of an electrically powered vehicle including increasing the number of rotations of the fan when the fan is in operation and a temperature of the electric storage device exceeds a first predetermined value.

According to the cooling method for an electric storage device of an electrically powered vehicle, while the cooler is in operation, if the temperature of the electric storage device increases and exceeds the first predetermined value, the number of rotations of the fan will increase. Thereby, the flow rate of the cooling air to be supplied to the electric storage device increases. Accordingly, the electric storage device can be cooled promptly by the adequate flow rate of cooling air to be supplied.

It may be arranged such that the cooling method for an electric storage device of an electrically powered vehicle further includes switching an air-supplying mode of the cooler to a cabin-interior-air circulation mode when the fan is in operation and the temperature of the electric storage device exceeds the first predetermined value.

In this case, when the cooler is in operation and if the temperature of the electric storage device increases and exceeds the first predetermined value, the controller increases the number of rotations of the fan and the air-supplying mode is switched to the cabin-interior-air circulation mode. With this operation, the cooling air is supplied to the electric storage device while terminating introduction of the ambient air. Accordingly, the electric storage device can be cooled efficiently by terminating the introduction of the ambient air having comparatively higher temperature into the cabin interior.

It may be arranged such that a requirement for increasing the number of rotations of the fan further includes that a temperature at a cabin exterior exceeds a second predetermined value.

In this case, when the cooler is in operation, if the temperature of the electric storage device increases and exceeds the first predetermined value and if the temperature of the ambient air outside the cabin exceeds the second predetermined value, the controller increases the number of rotations of the fan, and thereby increasing the flow rate of the cooling air supplied from the fan to the electric storage device. Accordingly, even when cooling performance for the electric storage device is lowered due to increasing ambient temperature, the electric storage device can be cooled promptly by the adequate flow rate of cooling air to be supplied to the suction port.

It may be arranged such that a requirement for increasing the number of rotations of the fan further includes that the insolation intensity exceeds a third predetermined value.

In this case, when the cooler is in operation, if the temperature of the electric storage device increases and exceeds the first predetermined value and if the insolation intensity exceeds the third predetermined value, the controller increases the number of rotations of the fan, and thereby increasing the flow rate of the cooling air supplied from the fan to the electric storage device. Accordingly, even when cooling performance for the electric storage device is lowered due to increasing insolation intensity, the electric storage device can be cooled promptly by the adequate flow rate of cooling air to be supplied to the electric storage device.

### BRIEF DESCRIPTION OF THE DRAWINGS

FIG. 1 shows a plan view schematically showing a vehicle according to one embodiment of the present invention.

FIG. 2 shows a side view schematically showing the vehicle.

FIG. 3 shows a flowchart for explaining a control in the same embodiment.

### DETAILED DESCRIPTION OF THE INVENTION

One embodiment of a cooling apparatus for a condenser of an electrically powered vehicle according to the present invention will be explained below with reference to the drawings. In the following explanation, directions such as forward, backward, left, and right correspond, if there is no particular description, to directions of the vehicle. Furthermore, in the drawings, an arrow F indicates a forward direction, an arrow R indicates a rearward direction, an allow L indicates a left direction, and an allow R indicates a right direction.

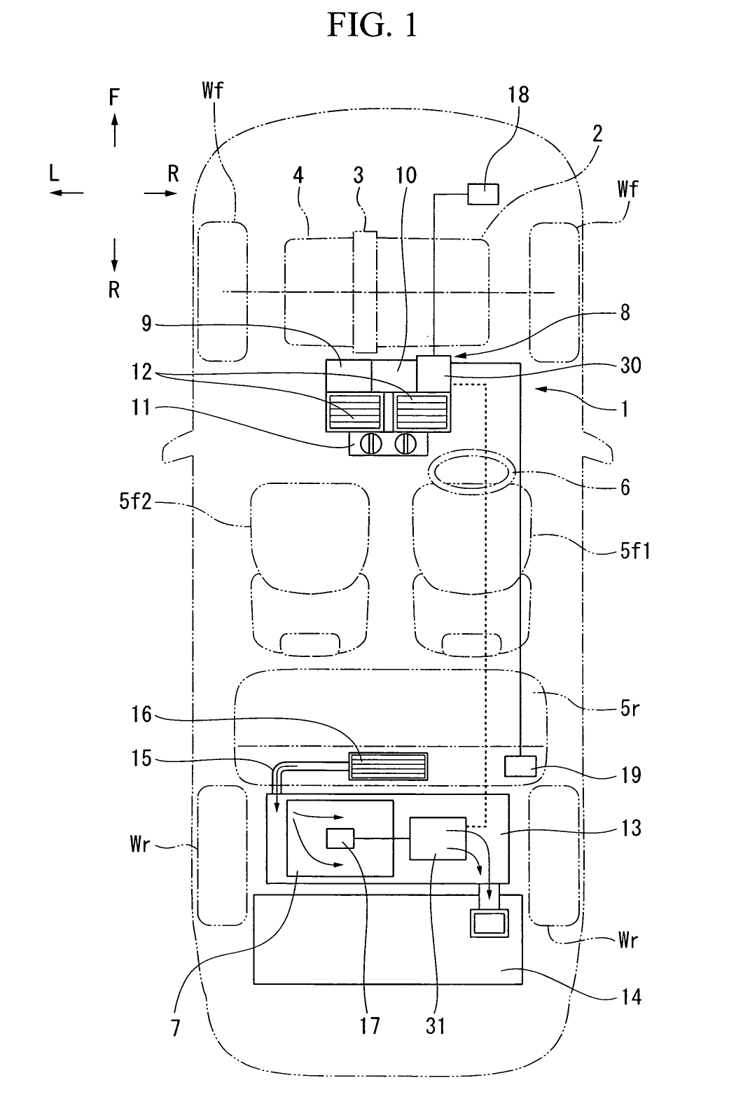

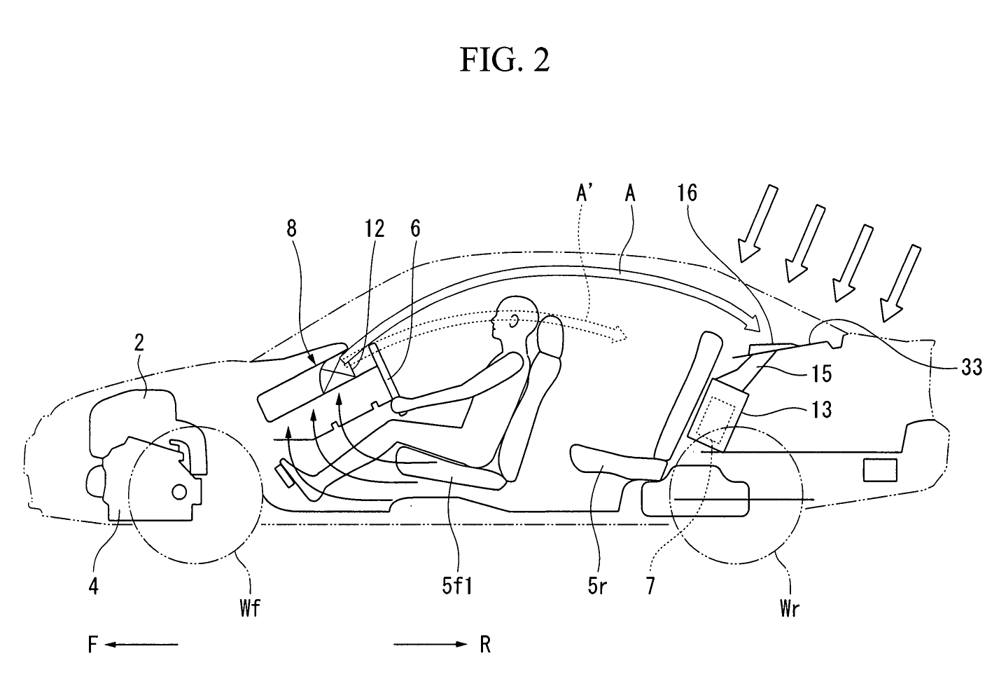

FIGS. 1 and 2 show a hybrid vehicle (an electrically powered vehicle) equipped with a cooling apparatus for a condenser of an electrically powered vehicle 1 of the present embodiment. This hybrid vehicle is so-called a parallel type in which an engine 2 and a motor generator 3 (a vehicle driving motor) are connected in series, and driving powers of these are transferred to driving wheels (for example, front wheels Wf) through a transmission 4. The motor generator 3 is configured by, for example, a three-phase brushless DC motor. In the drawings, a reference symbol 5f1 denotes a front seat on the driver seat side while a reference symbol 5f2 denotes another front seat on the passenger seat side. In addition, a reference symbol 5r denotes a rear seat, a reference symbol 6 denotes a handle, and reference symbols Wr denote rear wheels.

In this hybrid vehicle, when the hybrid vehicle is decelerating or the like, rotations of the front wheels are transferred to the motor generator and the motor generator 3 works as a generator, and thereby recovering the energy as so-called regenerative braking force. The recovered electrical energy is charged into a high-voltage battery 7 for driving and regeneration (an electric storage device) through non-illustrated PDU (Power Drive Unit). Moreover, the PDU includes an inverter as one of main components thereof. The PDU receives direct current from the battery 7 and converts it to three-phase alternating current when the motor generator is driven, while the PDU converts alternating current generated by the motor generator 3 to direct current when the motor generator 3 is in braking operation or the like.

An air conditioner unit 8 being one example of a cooler of the present invention is arranged in front of the front seats 5f1 and 5f2 inside the cabin interior. The air conditioner unit 8 is provided with a heat exchanging system (not illustrated in the figures), a blower 9 which is driven by a motor, and a switching mechanism 10 for switching air supplying modes. The switching mechanism 10 switches the air supplying modes by selecting an ambient air suction mode or an interior air circulation mode. At the ambient air suction mode, ambient air is continuously introduced into a cabin interior by opening an ambient air suction duct (not illustrated in the figures). In the interior air circulation mode, air inside the cabin interior is circulated by closing the ambient air suction duct. A compressor and the blower of the heat exchanging system, the switching mechanism and the like are controlled by an air conditioner CPU 30 (a controller). Moreover, in the drawings, a reference numeral 11 denotes an operation panel of the air conditioner unit 8, while the reference numeral 12 denotes an air diffuser of the air conditioner unit 8.

On the other hand, an electrical equipment box 13 is arranged at behind a backrest of the rear seat 5r. The electrical equipment box 13 has substantially a rectangular solid shape, and includes a battery 7 for driving and regeneration, and a battery CPU 31 (a controller) together with high-voltage electrical equipments such as the above-mentioned PDU and a DC-DC converter thereinside. Cooling air is introduced into an interior of the electrical equipment box 13. The introduced cooling air performs heat exchanging by cooling the battery 7, the battery CPU 31, and the high-voltage electrical equipments such as the above-mentioned PDU, and is thereafter exhausted toward a trunk 14 side. Air to be introduced into the electrical equipment box 13 is introduced from the cabin interior through a suction duct 15. One end on the cabin interior side of the suction duct 15 communicates with the cabin interior through a suction port 16 provided on a rear parcel 33 (refer to FIG. 2).

The battery 7 is equipped with a battery temperature sensor 17 (a battery temperature measuring device) for measuring temperature of the battery 7. Signals of the battery temperature sensor 17 are input into the battery CPU 31. In addition to the signals from the battery temperature sensor 17, the battery CPU 31 receives voltage signals from the battery 7 and requirement signals from an engine controller and the like, and thereby performing controls for supplying and charging electrical power in accordance with running condition.

The air conditioner CPU 30 is connected to an ambient temperature measuring sensor 18 (an ambient temperature measuring device) for measuring temperature outside the vehicle and an insolation intensity measuring sensor 19 (an insolation intensity measuring device) for measuring insolation intensity at the cabin interior through window glasses such as a rear window glass. The air conditioner CPU 30 receives the signals from theses sensors 18 and 19, and communication signal from the battery CPU 31. The air conditioner CPU 30 controls temperature and flow rate basically based on setting operations input into the operation panel 11. Furthermore, during the air conditioning, if signals are input into the air conditioner CPU 30 from the battery CPU 31 indicating that: both of the measured temperature by the ambient temperature measuring sensor 18 and the insolation intensity measured by the insolation intensity measuring sensor 19 exceed the predetermined temperature; and the temperature of the battery 7 exceeds the predetermined value, then the air conditioner CPU 30 will increase the rotational number of the blower 9 of the air conditioner unit 8.

Moreover, the battery cooling apparatus 1 of the present embodiment is provided with: the air conditioner unit 8 including the air conditioner CPU 30; the suction port 16, the suction duct 15, the electrical equipment box 13, the battery CPU 31, and the like.

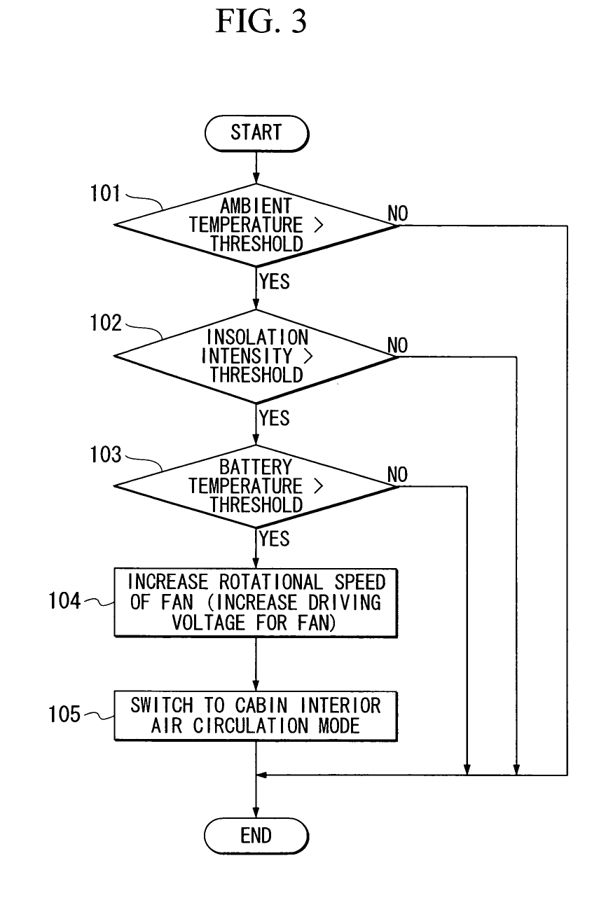

Control of the battery cooling apparatus 1 by the air conditioner CPU 30 and the battery CPU 31 will be explained below with reference to a flowchart of FIG. 3. Moreover, the following processes are to be performed while the air conditioner unit 8 performs air conditioning.

Firstly, at step 101, temperature measured by the ambient temperature sensor 18 and the threshold (an ambient temperature threshold of, for example, 40° C.) stored in a memory are compared. Then, the process passes through without doing anything if the measured temperature is equal to or less than the ambient temperature threshold (for example, 40° C.), or the process proceeds to the next step 102 if the measured temperature is higher than the ambient temperature threshold.

At step 102, the insolation intensity measured by the insolation intensity sensor 19 and the insolation intensity threshold (for example, 800 kcal/m²hr) stored in the memory are compared. Then the process passes through without doing anything if the measured insolation intensity is equal to or less than the insolation intensity threshold, or the process proceeds to the next step 103 if the measured insolation intensity is larger than the insolation intensity threshold.

At step 103, the temperature measured by the battery temperature sensor 17 and the battery temperature threshold stored in the memory are compared. Then, the process passes through without doing anything if the measured temperature is equal to or less than the battery temperature threshold, or the process proceeds to the next step 104 if the measured temperature is higher than the battery temperature threshold. Moreover, actual temperature comparison is performed by the battery CPU 31, and signals indicating the result of the comparison are transmitted to the air conditioning CPU 30.

At step 104, a command is ordered for increasing the number of rotations (i.e., for increasing the driving voltage) of the blower 9.

At subsequent step 105, a command is ordered to the switching mechanism 10 of the air conditioning unit 8 for switching the air supply mode to the cabin-interior-air circulation mode.

As has been explained in the above, when both of the measured ambient temperature and the measured insolation intensity are higher than the predetermined values and when the temperature of the battery 7 is higher than the predetermined value, the battery cooling apparatus 1 of the present embodiment switches the air supply mode to the cabin-interior-air circulation mode, and increases the number of rotations of the blower 9. As a result, the flow rate shown in for example an arrow A′ in FIG. 2 will increase to arrow A, and thereby promptly supplying cooling air to the suction port 16. Accordingly, the cooling air in the cabin interior is actively supplied into the electrical equipment box 13 through the suction port 16, and thereby promptly cooling heat emitting parts such as the battery 7. Furthermore, at this time, since the air-supplying mode is switched to the cabin-interior-air circulation mode by terminating introducing the ambient air, a space (i.e., air) from the cabin interior to the inside of the electrical equipment box 13 can be efficiently cooled.

The battery cooling apparatus 1 of the present embodiment may be arranged such that: only the temperature of the battery 7 is monitored; and the flow rate of the blower 9 is increased when the battery temperature exceeds the predetermined temperature. However, in the battery cooling apparatus 1 of the present embodiment, a requirement for increasing the flow rate of the blower 9 is set such that both of the ambient temperature and the insolation intensity exceed the predetermined values; therefore, prompt cooling of the battery 7 can be performed with low frequency as less as possible only when temperature around the suction port 16 has a high possibility of being increased. Accordingly, the battery cooling apparatus 1 will not provide uncomfortableness due to frequent flow rate changes toward occupants.

Moreover, the present invention is not limited to the above-mentioned embodiment, and modifications can be made without departing from the spirit or scope of the present invention. For example, in the above-mentioned embodiment, the battery 7 is arranged behind the backrest of the rear seat 5r; however, the battery 7 may be arranged at other positions such as under the floor of the cabin interior. In addition, in the above-mentioned embodiment, prompt cooling of the battery 7 is controlled by cooperation of the air conditioner CPU 30 and the battery CPU 31; however, for example, the same control can be made only by the air conditioner CPU 30 by, for example, adding a temperature monitoring function of the battery 7 to the air conditioner CPU 30.

In addition, in the above-mentioned embodiment, only the number of rotations of the blower 9 is increased when the temperature of the battery 7 rises and exceeds the predetermined value; however, in addition to increasing the number of rotations of the blower 9, the compression volume of a compressor and throttling amount of a decompressing device may be increased in order to increase the cooling performance of the cooling cycle (not illustrated).

Furthermore, in the above-mentioned embodiment, the cooling apparatus according to the present invention is applied to a hybrid vehicle; however, it is also applicable to an electric car which uses only a motor as a driving source. Furthermore, in the above-mentioned embodiment, the battery is employed for the condenser; however, a capacitor may be employed in place of the battery.

While preferred embodiment of the invention has been described and illustrated above, it should be understood that this is exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A cooling apparatus for an electric storage device of an electrically powered vehicle including a vehicle driving motor to which an electrical power is supplied from an electric storage device through an inverter, comprising:
a cooler including a fan which sends a cooling air into a cabin interior;
a suction port which is open to the cabin interior so as to suck the cooling air and supplies the cooling air toward the electric storage device; and
a controller which increases the number of rotations of the fan when the fan is in operation and a temperature of the electric storage device exceeds a first predetermined value.

2. The cooling apparatus for an electric storage device of an electrically powered vehicle according to claim 1, wherein
when the fan is in operation and the temperature of the electric storage device exceeds the first predetermined value, the controller switches an air-supplying mode of the cooler to a cabin-interior-air circulation mode.

3. The cooling apparatus for an electric storage device of an electrically powered vehicle according to claim 1, further comprising an ambient temperature measuring device which measures an ambient temperature outside the electrically powered vehicle, wherein
a requirement for the controller to increase the number of rotations of the fan further includes that a temperature at a cabin exterior exceeds a second predetermined value.

4. The cooling apparatus for an electric storage device of an electrically powered vehicle according to claim 1, further comprising an insolation intensity measuring device which measures an insolation intensity, wherein
a requirement for the controller to increase the number of rotations of the fan further includes that the insolation intensity exceeds a third predetermined value.

5. A cooling method for an electric storage device of an electrically powered vehicle including a vehicle driving motor to which an electrical power is supplied from an electric storage device through an inverter, the electric storage device being cooled by a cooling air supplied from a cooler by a fan of the cooler, the cooling method for an electric storage device of an electrically powered vehicle comprising
increasing the number of rotations of the fan when the fan is in operation and a temperature of the electric storage device exceeds a first predetermined value.

6. The cooling method for an electric storage device of an electrically powered vehicle according to claim 5, further comprising
switching an air-supplying mode of the cooler to a cabin-interior-air circulation mode when the fan is in operation and the temperature of the electric storage device exceeds the first predetermined value.

7. The cooling method for an electric storage device of an electrically powered vehicle according to claim 5, wherein
a requirement for increasing the number of rotations of the fan further includes that a temperature at a cabin exterior exceeds a second predetermined value.

8. The cooling method for an electric storage device of an electrically powered vehicle according to claim 5, wherein
a requirement for increasing the number of rotations of the fan further includes that the insolation intensity exceeds a third predetermined value.
